(19) United States
(12) Patent Application Publication
(10) Pub. No.: US 2025/0256687 A1
(43) Pub. Date: Aug. 14, 2025

(54) VEHICLE TIRE ALIGNMENT SYSTEM AND A METHOD OF ALIGNING TIRES OF A VEHICLE

(71) Applicants: Curtis Clark, Delaware, OH (US); Curtis Clark, JR., Delaware, OH (US)

(72) Inventors: Curtis Clark, Delaware, OH (US); Curtis Clark, JR., Delaware, OH (US)

(21) Appl. No.: 18/438,901

(22) Filed: Feb. 12, 2024

(51) Int. Cl. B60S 5/00; G01B 11/275

(52) U.S. Cl. CPC B60S 5/00; G01B 11/2755; G01B 2210/28

(57) ABSTRACT

A vehicle tire alignment system is provided herein. The system comprises a laser and a corresponding light detection device which sounds an alarm when the laser is aligned with the light detection device. Both the laser and the light detection device are located within housings facing each other. The housings are set on separate cylindrical tubes, which in turn are set on separate adapters which adapters either fit over the studs and onto the rotors of two wheels on one side of a vehicle or are inserted into center cap holes in the hubcap. A user can then adjust the tie rods on the vehicle until the laser facing the light detection device is in alignment with the light detection device, which alignment is announced by the activation of the alarm. The system is simple enough to be employed by a do-it-yourself user and does not require any computers or cameras, can be employed without the need to use a full vehicle lift, and can be conducted with basic tools.

### CROSS-REFERENCE TO RELATED APPLICATIONS

This application claims the benefit of U.S. Provisional Patent Application Ser. No. 63/488,073, filed on Feb. 24, 2023, which is incorporated by reference herein in its entirety.

### FIELD OF THE INVENTION

The present invention relates generally to the field of automotive maintenance. More particularly, the present invention relates generally to the alignment of vehicle tires.

### BACKGROUND OF THE INVENTION

Most vehicles will require that their alignment systems be adjusted from time to time. The most often time such occurs is before the replacement of new tires on a vehicle. At such time, the old tires are removed and the various parameters of alignment, i.e., camber, toe, caster and thrust, are adjusted to the manufacturer's specifications. Such can prevent premature tire wear and improve the driving experience by avoiding undesirable shaking of the tires as they rotate. Properly timed alignments also can avoid unnecessary wear and tear on the suspension and steering systems of the vehicle.

Known alignment systems are extremely diverse and can include string based systems, mechanical measurement systems, optical alignment systems, target alignment systems, and camera imaging (machine vision) systems. All of the devices which are available today for aligning a vehicle require significant setup time before actual alignment functions are performed on the vehicle. Production and dedicated alignment machines are cumbersome and are not designed to be transportable. Thus, portability and simplicity of use are not found in most alignment machines today.

Automotive research related to alignment is well developed but is constantly changing with advances in vehicle suspension design and handling, all of which render vehicles more complicated in terms of maintenance and repair. Most commonly driven vehicles have a preferred alignment set-up depending on the application and conditions. Other vehicles which are designed for special purposes, must even more so maintain the alignment. This is particularly important for special purpose vehicles used in high performance applications, such as racing vehicles, where minor changes in alignment can have significant impacts effecting not only the handling of the vehicle but vehicle stability, rolling resistance, tire adhesion, tire wear management and high speed control, not to mention fuel mileage considerations. However proper wheel alignment is important for all vehicles, such as racecars, trucks, cars, airplanes, trains, motorcycles, go-karts, mopeds.

As noted above, most vehicle service facilities are equipped with sophisticated and expensive wheel and vehicle alignment systems which require training and experience in order to be effectively used to align a vehicle. However, such technologically advanced systems are beyond the financial and technical abilities of most vehicle owners.

With the continual change in economic conditions due to financial downturns many vehicle owners seek to minimize the financial expenditures for their vehicles. Other vehicle owners prefer to maintain their own vehicles to the extent that they are able to do so. This avoids the owner having to surrender the automobile for a period of time and also provides the owner with a sense of self-reliance and accomplishment by addressing their own automotive needs. Such do-it-yourselfers (DIY) though are for the most part not able to align the wheels in their vehicles even with a great deal of technical knowledge. The reason, as noted above, is that the equipment required is costly, very large and requires experience and training. Thus, even most DIY users will tend to take their vehicles to a professional automotive technician to align their wheels when needed.

Accordingly, there remains a need for a solution to at least one of the aforementioned problems. For instance, there is an established need for a system to align vehicle wheels which is small, portable, affordable, and easy to use and apply not only for DIY users but for anyone.

### SUMMARY OF THE INVENTION

The present invention can be directed to a system for aligning tires of vehicles. The system comprises a laser and a corresponding light detection device which sounds an alarm when the laser is aligned with the light detection device. Both the laser and the light detection device are located within housings facing each other. The housings are set on the ends of separate cylindrical tubes, which in turn are set on either (i) separate circular disk-shaped adapters which circular disk-shaped adapters either fit over the studs and onto the rotors of two wheels on one side of a vehicle, or alternatively, (ii) a longitudinal adapter capable of being attached to the center portion of hubcaps when the center cap of the hubcap is removed, e.g. by an expanding screw lock that expands in the center cap hole. Whichever adapter is used, a user can then adjust the tie rods on the vehicle until the laser facing the light detection device is in alignment with the light detection device, which alignment is announced by the activation of the alarm. The system is simple enough to be employed by a do-it-yourself user and does not require any computers or cameras, can be employed without the need to use a full vehicle lift, and can be conducted with basic tools.

The term “about” as used herein can entail a variance of 10% greater or lower than the value recited.

The term “comprising” as used herein also encompasses the terms “consisting essentially of” and “consisting of”.

The values of any endpoint(s) of any range(s) recited herein can be used to create different ranges or different endpoints of ranges described herein.

It can be understood herein that the term “vehicle” or “vehicular” or other similar term as used herein is inclusive of motor vehicles in general, such as passenger automobiles including sports utility vehicles (SUV), buses, trucks; and various commercial vehicles; and includes hybrid vehicles, plug-in hybrid electric vehicles, and the like. As referred to herein, a hybrid vehicle is a vehicle that has two or more sources of power, for example, both gasoline-powered and electric-powered vehicles.

In a first implementation of the invention there can be provided a vehicle tire alignment system comprising:
two circular disk-shaped adapters each having an adapter circumference, an inner solid circular center having a circular center circumference, which is less than, and is centered within, the adapter circumference, and wherein an area between the circular center circumference and the adapter circumference contains at least four arced stadium shaped apertures therethrough;
two cylindrical tubes each having a longitudinal length and a circumference substantially equivalent to the circular center circumference and wherein the longitudinal length of each cylindrical tube extends in a direction directly centered on and perpendicular from one of the inner solid circular centers;
a laser housing containing a laser therein, which laser housing is situated on an end of one of the cylindrical tubes which end opposes an end of the cylindrical tube which extends perpendicularly from inner solid circular center, and wherein the laser is oriented in a direction perpendicular to the longitudinal length of the cylindrical tube; and,
an audible alarm housing containing an opening, a light detection device in line with the opening, and an audible alarm connected to the light detection device, wherein the audible alarm housing is situated on an end of the other of the two cylindrical tubes, which end opposes an end of the cylindrical tube which extends perpendicularly from the inner solid circular center, and wherein the opening in the audible alarm housing is oriented in a direction opposing the laser direction.

In one aspect of the invention, the vehicle can be a passenger car.

In another aspect of the invention, the circular disk-shaped adapters are made of plastic, metal, or ceramic materials. Some suitable examples of a durable resin plastic material can those selected from the group consisting of high-density polyethylene, acetal, acrylonitrile butadiene styrene, polycarbonate, nylon, poly ethylene terephthalate, polybutylene terephthalate, polyvinyl chloride, and combinations thereof. Some suitable metal materials can be steel, iron, stainless steel, aluminum and aluminum alloys. The circular disk-shaped adapters can be solid or hollow, but preferably are solid with the herein described apertures therethrough. The circular disk-shaped adapters can have a thickness of from about 0.5 inches up to about 3 inches and preferably from about 1 inch up to about 2 inches. The circular disk-shaped adapters can have a diameter of from about 8 inches up to about 20 inches, preferably from about 10 inches up to about 18 inches, and most preferably from about 12 inches up to about 16 inches. The diameter of the inner solid circular center has a diameter of from about 4 inches up to about 16 inches, preferably from about 6 inches up to about 8 inches. In one embodiment, the circular disk-shaped adapters can be concentric around inner solid circular center.

In yet another aspect of the invention, the circular disk-shaped adapters have at least 5 apertures therethrough. The apertures have an arc of about 20° to about 50°, preferably from about 25° to about 35°. The apertures can run along the inside of the circumference of the circular disk shaped adapter and outside the circumference of the inner solid circular center. The stadium shaped apertures can be from about 2 inches up to about 5 inches, preferably from about 3 inches up to about 4 inches in length from one longitudinal end of the stadium shaped aperture to the other longitudinal end. The width of the apertures can be from about 1.5 inches up to about 4 inches, preferably from about 2 inches to about 3 inches. When placed on the rotor the circular disk-shaped adapter can be rotated clockwise or counterclockwise to be able to be placed over all of the wheel studs of the wheel. The at least four arced stadium shaped apertures are equally placed from each other.

In yet even another aspect of the invention, the two cylindrical tubes each have a longitudinal length of from about 6 inches up to about 24 inches, preferably from about 8 inches up to about 18 inches. The circumference of the cylindrically tubes being substantially equivalent to the circular center circumference can be a circumference which is from about 1% up to about 20%, preferably from about 5% up to about 10% less than the circumference of the inner solid circular center. Preferably such can be a difference of from about 0.5 inches up to about 3 inches less, more preferably about 1 inch up to about 2 inches less.

In yet one other aspect of the invention, the cylindrical tubes can be made of any of the materials described herein above for the circular disk-shaped adapters, but preferably can be any of the aforementioned plastic materials. The cylindrical tubes can be solid or hollow, although preferably they can be solid.

In yet even one other aspect of the invention the longitudinal length of each cylindrical tubes extending in a direction directly centered on and perpendicular from one of the inner solid centers is to be understood to mean that the tube emanates perpendicularly and directly from a side of the circular disk shaped adapter, i.e., the side opposite by which the adapter is secured onto a rotor of a vehicle. The cylindrical tube emanates by its longitudinal length therefrom such that it is substantially flush with the inner solid center, e.g., less than ½ inch difference in circumference along its longitudinal length.

In yet still one other aspect of the invention, the laser housing can be made of any suitable material such as wood, plastic, metal and the like and preferably can be made of any of the above noted metal or plastic materials. The laser housing can be of any suitable shape such as but not limited to square, rectangular, cylindrical, triangular, hexagonal, octagonal and the like. The laser housing can be of any suitable size provided it is sufficient to house the laser therein. Preferably the housing is rectangular, and the laser lies along the bottom of the longitudinal length of the rectangular housing. The housing can have openings along the top and/or bottom or along each longitudinal end to insert and remove the laser and to situate it therein. The housing can also have a level therein which can provide for a determination of the level status of the laser when activated. The housing can also have an access window therein to observe the level therein to make sure the housing is level when the system is attached to a wheel.

In yet still even another aspect of the invention, the laser employed in the laser housing can be any conventional light laser that is commercially available, and which would be detectable by the light detection device described herein. The laser can be of the type such as those used in security systems which presents a beam of light, visible or invisible, which in turn can be detected by the light detection device as described herein. In one embodiment the laser and light detection device together can be the kind employed in an infrared motion detector. A motion detector can contain four parts: the laser, mirrors, the detector, and the sensing electronics. The laser of the infrared motion detector can project a beam of light that shoots across the space between the laser housing and the audible alarm housing into a series of mirrors inside the audible alarm housing and finally into a detector, or directly into a detector, which detector emits a particular voltage into the sensing electronics when the laser hits it which then triggers an alarm. When the beam of light is not hitting the detector, the detector receives a certain voltage which does not set off the alarm. The laser can also be in one non-limiting embodiment a simple laser pointer, such as those which are commercially available.

In another aspect of the invention, the laser housing in which the laser is situated can be oriented such that the laser is emitted from a hole in the laser housing in the direction of the other portion of the system, i.e., the audible alarm housing, specifically into an opening within the audible alarm housing for receiving the laser emission from the laser housing, and wherein the audible alarm housing is situated on an identical cylinder end emanating from the solid center of an identical adapter, which end is also opposite the end which mates with the adapter. The orientation of the laser can be perpendicular as is understood that the direction of the laser would be oriented in a perpendicular direction to the face of the end of cylindrical tube which is opposite that which is attached to the adapter end.

In yet another aspect of the invention, the opening in the audible alarm housing can be sufficient to receive the laser emission from the laser housing. Such an opening in both the laser housing and the audible alarm housing can be a circular opening with a diameter of from ¼ of an inch up to about 3 inches, preferably from ½ of an inch up to about 2 inches in diameter. As noted above, the light detection device can be any light detector device, such as those selected from the group consisting of photoresistors, photodiodes, and phototransistors. Preferably the light detection device can be a type of photoresistor which is a light dependent resistor (LDR). LDR's made of cadmium sulfide are one non-limiting example of a suitable light detector device. One such non-limiting example can be an LDR from Night Fire Electronics, LLC and is available as the Laser Triggered American Siren.

In yet even another aspect of the invention, the audible alarm housing can be of any of the materials and shapes and sizes as described above for the laser housing. The audible alarm housing can also house the alarm which can be a speaker which emits an audible sound to the human ear in the air at room temperature and at 1 atmosphere in pressure. The alarm can be any commercially available alarm as would be known to those of ordinary skill in the art. As described above for the laser housing, the audible alarm housing can be situated on an end of the cylindrical tube, which end opposes an end of the cylindrical tube which extends perpendicularly from the inner solid circular center, and wherein the opening in the audible alarm housing is oriented in a direction opposing the laser direction emanating from the laser housing.

In a second implementation of the invention there can be provided a vehicle tire alignment system comprising:
two longitudinal adapters each having one hubcap engaging end capable of being attached into the center cap hole of a hubcap when the center cap of the hubcap is removed, an opposing screwcap lid end having threading, and a threaded screw portion therebetween;
two cylindrical tubes each having screwcap lid engaging end which has a terminal internal threading which is complementary to the threading of the screwcap lid end, an opposing housing engaging end, and a circumference substantially equivalent to the circumference of the screwcap lid end;
a laser housing containing a laser therein, which laser housing is situated on the housing engaging end of one of the cylindrical tubes, and wherein the laser is oriented in a direction perpendicular to the longitudinal length of the cylindrical tube; and,
an audible alarm housing containing an opening, a light detection device in line with the opening, and an audible alarm connected to the light detection device, wherein the audible alarm housing is situated on the housing engaging end of the other of the two cylindrical tubes, and wherein the opening in the audible alarm housing is oriented in a direction opposing the laser direction.

In one aspect of the invention, the two longitudinal adapters are capable of being altered in longitudinal length employing the threaded screw portion and by turning an adjustment nut located thereon to lengthen or shorten the length of the adapter, and preferably the hubcap engaging end contains a central cylinder and an extending section at an end thereof, which extends from the end of the adapter, and which is capable of engaging an internal portion of a center cap hole in a hubcap, by having an appropriate complementary shape or configuration as would be known by those of ordinary skill in the art.

In one aspect of the invention, the central cylinder further comprises external arced shims placed therearound with their rounded sides on the external circumference of the cylinder, and which are capable of adjusting a circumference of the hubcap engaging end to different sized center cap holes by employing different thickness shims.

In a third implementation of the invention there can be provided herein a method of aligning tires of a vehicle comprising:
providing a vehicle tire alignment system comprising:
   two circular disk-shaped adapters each having an adapter circumference, an inner solid circular center having a circular center circumference, which is less than, and is centered within, the adapter circumference, and wherein an area between the circular center circumference and the adapter circumference contains at least four arced stadium shaped apertures therethrough;
   two cylindrical tubes each having a longitudinal length and a circumference substantially equivalent to the circular center circumference and wherein the longitudinal length of each cylindrical tube extends in a direction directly centered on and perpendicular from one of the inner solid circular centers;
   a laser housing containing a laser therein, which laser housing is situated on an end of one of the cylindrical tubes which end opposes an end of the cylindrical tube which extends perpendicularly from inner solid circular center, and wherein the laser is oriented in a direction perpendicular to the longitudinal length of the cylindrical tube; and,
   an audible alarm housing containing an opening, a light detection device in line with the opening, and an audible alarm connected to the light detection device, wherein the audible alarm housing is situated on an end of the other of the two cylindrical tubes, which end opposes an end of the cylindrical tube which extends perpendicularly from the inner solid circular center, and wherein the opening in the audible alarm housing is oriented in a direction opposing the laser direction;
jacking up one side of a vehicle;
removing both tires from one side of the vehicle to expose both rotors and studs;
placing the portion of vehicle tire alignment system with laser housing over the studs and onto the rotor of one wheel, preferably a front wheel, by the circular disk-shaped adapter side;
placing the portion of the vehicle tire alignment system with the audible alarm housing over the studs and onto the rotor of the other wheel, preferably a rear wheel, by the circular disk-shaped adapter side; and,
adjusting a tie rod on the vehicle until the audible alarm sounds.

In yet one other aspect of the invention, the step of jacking up one side of the vehicle can be such that the side of the vehicle is raised to a level condition at which level condition the vehicle would operate at if it contained the vehicle tires thereon. The step of jacking up one side of the vehicle can further comprise employing jack stands to situate the side of the vehicle the above noted level position.

In yet still one other aspect of the invention, placing the portion of vehicle tire alignment system with laser housing over the studs and onto the rotor of one wheel by the circular disk-shaped adapter side can further comprise sliding the system over the studs and affixing the lug nuts of the tire onto the studs which emanate from the apertures in the adapter such that the adapter is flush with the rotor of the vehicle wheel. The same can be conducted with the portion of the system comprising audible alarm housing provide the opening on the laser housing points towards the opening on the audible alarm housing.

In yet still even another aspect of the invention, after the alignment of the tires/wheels on one side of the housing, i.e., an alignment of any one or more of the toe, camber, caster and thrust the system can be removed from the wheels on the one side of the vehicle and then the process can be repeated on the other side of the vehicle.

In a fourth implementation of the invention there can be provided herein a method of aligning tires of a vehicle comprising:
providing a vehicle tire alignment system comprising:
   two longitudinal adapters each having one hubcap engaging end capable of being attached into the center cap hole of a hubcap when the center cap of the hubcap is removed, an opposing screwcap lid end having threading, and a threaded screw portion therebetween;
   two cylindrical tubes each having screwcap lid engaging end which has a terminal internal threading which is complementary to the threading of the screwcap lid end, an opposing housing engaging end, and a circumference substantially equivalent to the circumference of the screwcap lid end;
   a laser housing containing a laser therein, which laser housing is situated on the housing engaging end of one of the cylindrical tubes, and wherein the laser is oriented in a direction perpendicular to the longitudinal length of the cylindrical tube; and,
   an audible alarm housing containing an opening, a light detection device in line with the opening, and an audible alarm connected to the light detection device, wherein the audible alarm housing is situated on the housing engaging end of the other of the two cylindrical tubes, and wherein the opening in the audible alarm housing is oriented in a direction opposing the laser direction;
jacking up one side of a vehicle;
removing the center caps from each of two wheels on the side of the vehicle that has been jacked up to expose a hubcap center hole in each wheel;
placing the hubcap engaging end of each longitudinal adapter into a separate hubcap center hole; and,
adjusting a tie rod on the vehicle until the audible alarm sounds.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front perspective view of the tire alignment system of the present invention;

FIG. 2 presents a rear perspective view of the tire alignment system of the present invention;

FIG. 3 presents an exploded view of the means of attachment of the tire alignment system to the rotors of a vehicle;

FIG. 4 presents a view of the actuation of the laser and alarm of the tire alignment system of the present invention;

FIG. 5 presents a side view of the internal components of the laser housing and audible alarm housing of the tire alignment system;

FIG. 6 presents a rear perspective view of the tire alignment system mounted on the rotors of a vehicle with the points of alignment being depicted.

FIG. 7 presents a view of a longitudinal adapter of the present invention;

FIG. 8 presents a view of the longitudinal adapters of FIG. 7 being affixed to the cylindrical tubes of the present invention; and,

FIG. 9 presents a view of the tire alignment system of the present invention which employs the longitudinal adapters being attached to the center cap holes of two wheels.

Like reference numerals refer to like parts throughout the several views of the drawings.

### DETAILED DESCRIPTION

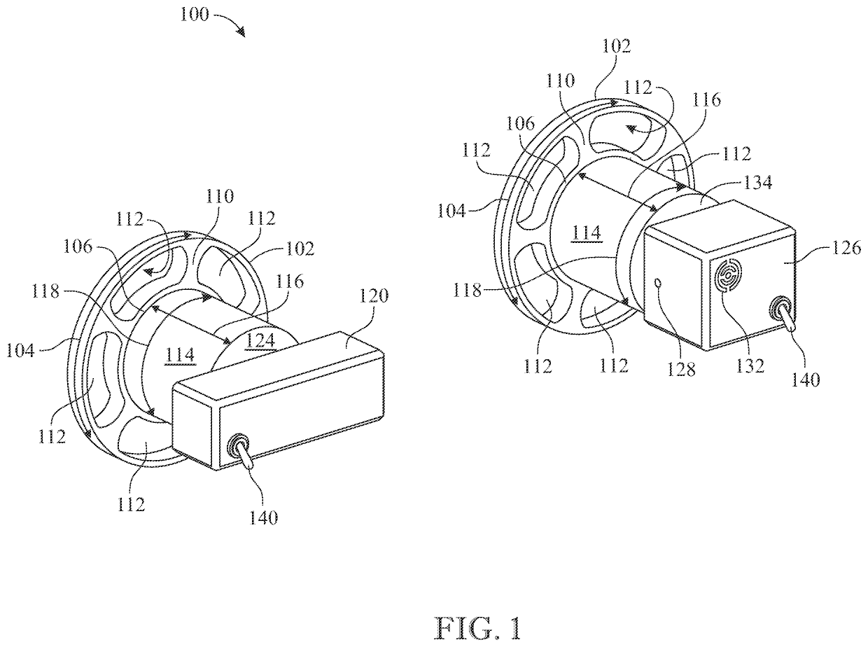

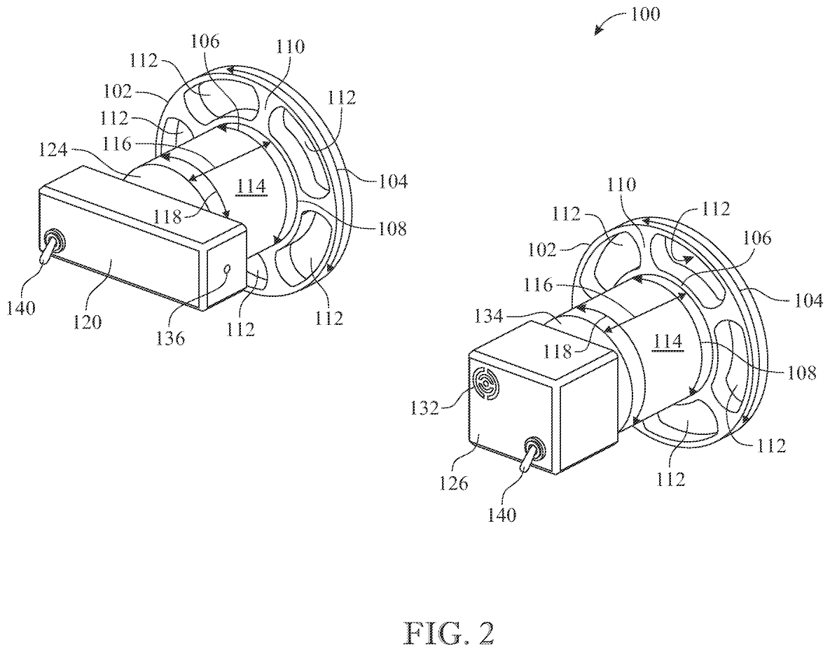

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1 and/or FIG. 2. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring initially to FIGS. 1 and 2, there is provided a vehicle tire alignment system 100 (herein after alignment system 100). The alignment system 100 can contain two circular disk-shaped adapters 102. The circular disk-shaped adapters 102 can each have an adapter circumference 104, an inner solid circular center 106 which has a circular center circumference 108. The circular center circumference 108 is less than, and is centered within, the adapter circumference 104. An area 110 is located between the circular center circumference 108 and the adapter circumference 104. The area 110 contains at least four, preferably at least five arced stadium shaped apertures 112 therethrough.

Still referring to FIGS. 1 and 2, the alignment system 100 can further comprise two cylindrical tubes 114 each having a longitudinal length 116 and a circumference 118 which is substantially equivalent to the circular center circumference 108. The longitudinal length 116 of each cylindrical tube 114 extends in a direction directly centered on and perpendicular from its respective corresponding the inner solid circular centers 106. The cylindrical tubes 114 can be attached to the circular disk-shaped adapters 102 via any conventional means such as adhesive, welding, thermo-welding, and fasteners (not shown).

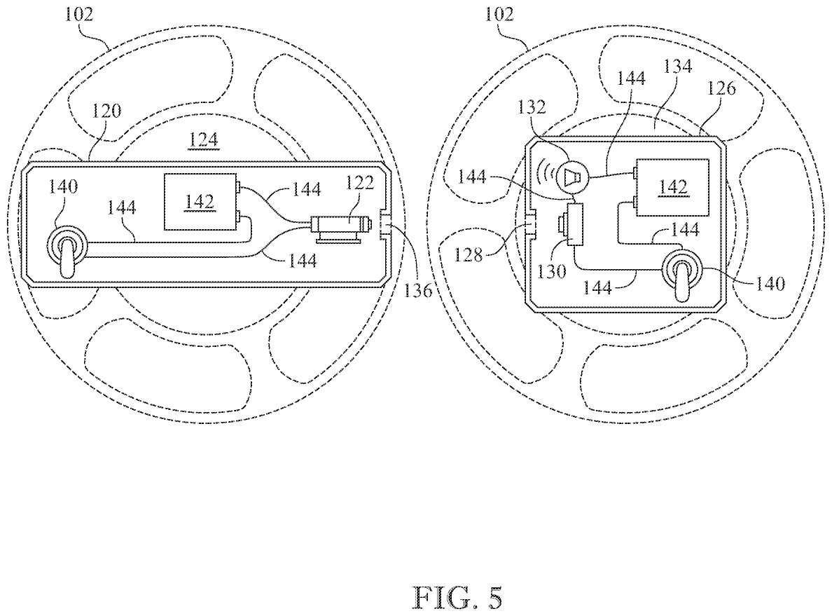

Still referring to FIGS. 1 and 2, and now further to FIG. 5, the alignment system 100 further comprises a laser housing 120 containing a laser 122 therein, which laser housing 120 is situated on an end 124 of the cylindrical tube 114 which extends perpendicularly from its respective inner solid circular center 106, and wherein the laser 122 is oriented in a direction perpendicular to the longitudinal length 116 of the cylindrical tube 114. The laser housing 120 can contain a hole 136 from which the laser 122 can emit a laser beam 138 in the direction of the other portion of the alignment system 100, which is the audible alarm housing 126 described herein below. The laser beam 138 is specifically emitted into an opening 128 within the audible alarm housing 126 for receiving the laser beam (emission) 138 from the laser housing 120. Similar to above the laser housing 120 and the audible alarm housing 126 can be attached to the cylindrical tubes 114 by the either of the ends 124 and 134, respectively, preferably 134, using any of the above described conventional means of attachment.

Still referring to FIGS. 1 and 2, the alignment system 100 can further comprise an audible alarm housing 126 containing an opening 128, a light detection device 130 in line with the opening 128, and an audible alarm 132 connected to the light detection device 130, wherein the audible alarm housing 126 is situated on an end 134 of the other of the two cylindrical tubes 114, which end 134 opposes an end of the cylindrical tube 114 which extends perpendicularly from its respective inner solid circular center 106, and wherein the opening 128 in the audible alarm housing 126 is oriented in a direction opposing the laser 122 direction.

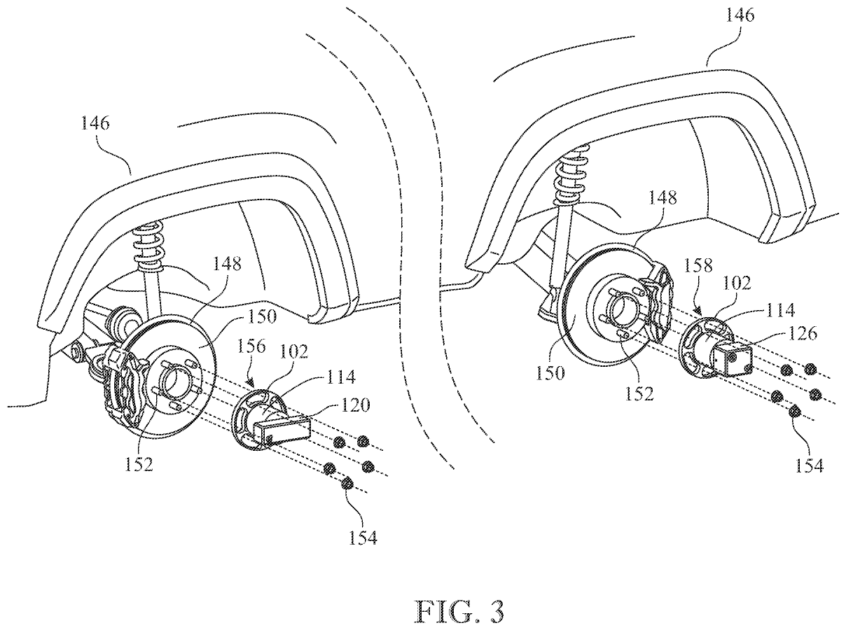

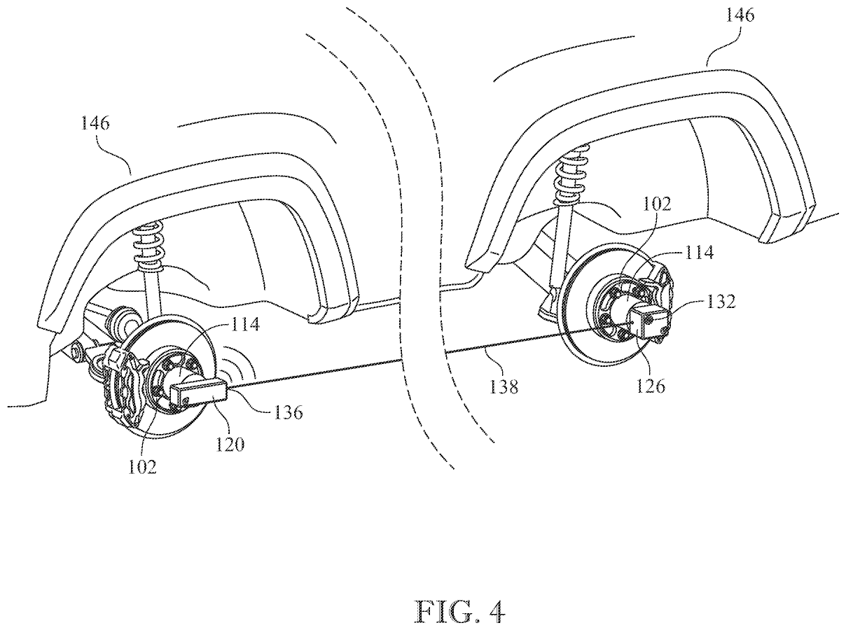

Referring to FIGS. 3 and 4, the alignment system 100 (as shown in FIGS. 1-2) is applied onto a vehicle 146. The vehicle 146 has wheels 148 each of which contain a rotor 150. The circular disk-shaped adapters 102 are installed onto the rotors 150 of the wheels 148 by passing the circular disk-shaped adapters 102 over the wheel studs 152 such that the wheel studs pass through the arced stadium shaped apertures 112 and the circular disk-shaped adapters are secured to the rotors 150 by screwing the lug nuts 154 thereover.

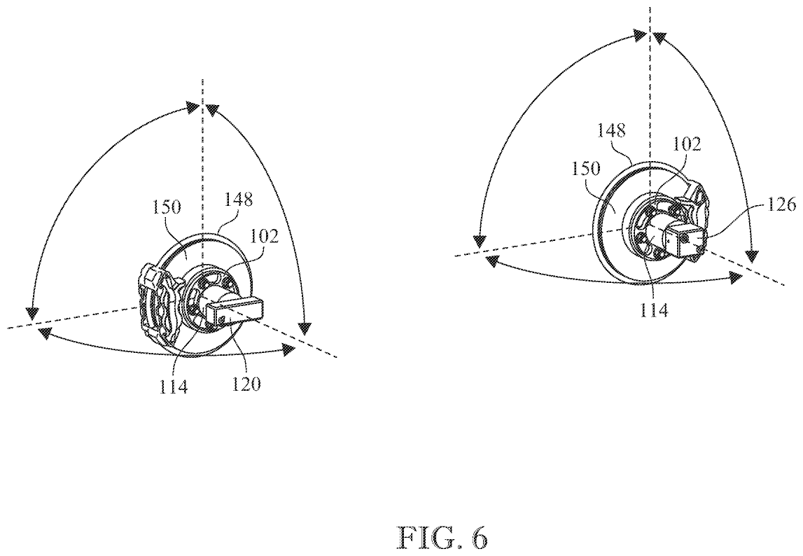

Referring to FIGS. 5 and 6, the orientation of the laser 122 emanates the laser beam 138 out of the hole 136 and into the opening 128 of the laser housing 120 such that the laser beam 138 hits the light detection device 130 which is electrically connected to the audible alarm 132. Each of the laser housing 120 and the audible alarm housing 126 can also have an on/off switch 140, such as a toggle switch 140, which can be electrically connected to a battery 142, and in the audible alarm housing 126 to the light detection device 130, and in the laser housing to the laser 122, both through an electrical connection 144. The battery 142 in the audible alarm housing 126 can power the audible alarm 132 as well as the light detection device 130 through an electrical connection 144. The battery 142 in the laser housing 120 can power the laser 122 through an electrical connection 144.

Referring to FIGS. 3, 4 and 6, in the method(s) as described herein, such can comprise (i) providing the alignment system 100; (ii) jacking up (not shown) one side of the vehicle 146; (iii) removing both tires (not shown) from one side of the vehicle 146 to expose both rotors 150 and wheel studs 152; (iv) placing the portion of alignment system 100 with the laser housing 120 (left hand side image in FIGS. 3, 4 and 6) over the studs 152 and onto the rotor 150 of one wheel 148, preferably a front wheel 148, by the circular disk-shaped adapter side 156, optionally securing lug nuts 154 onto the studs 152; (v) placing the portion of the alignment system 100 with the audible alarm housing 126 over the studs 152 and onto the rotor 150 of the other wheel 148, preferably the rear wheel 148, by the circular disk-shaped adapter side 158, optionally securing lug nuts 154 onto the studs 152; and, (vi) adjusting a tie rod (not shown), by turning a tie rod adjustment screw (not shown) on the vehicle 146, and/or adjusting any other adjustment devices connected to the wheel 148 until the laser beam 138 aligns with the light detection device 130 and the audible alarm 132 sounds. The specific adjustments to wheel alignment are known to those skilled in the art and some are shown in FIG. 6 by the arrows therein. The steps (iv) and (v) can be conducted in either order.

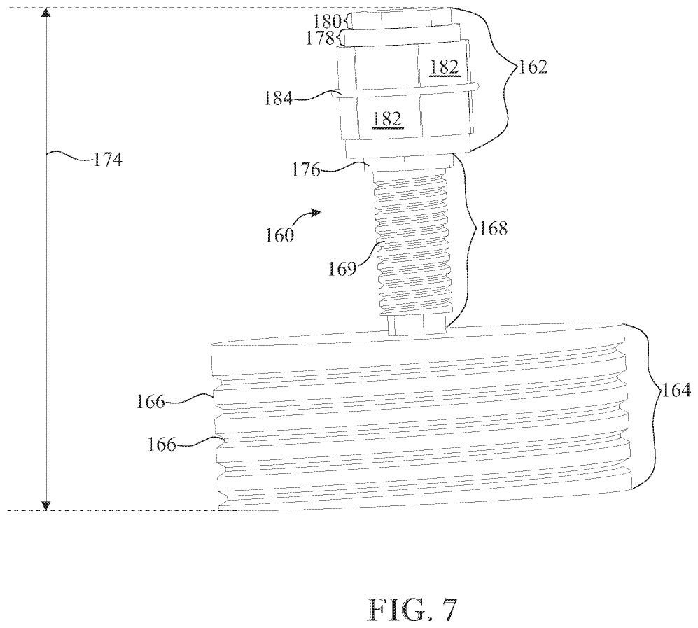

Referring to FIGS. 7-9, there is provided herein an alternative alignment system 100 wherein the circular disk shaped adapters 102 (see FIG. 1) are replaced with longitudinal adapters 160 (see FIG. 7). The longitudinal adapters 160, there being preferably two in each system 100, contain a hubcap engaging end 162, which is configured such that it is capable of being attached into the center cap hole of a hubcap when the center cap of the hubcap is removed. The attachment of the system 100 with the longitudinal adapters 160 to a hubcap is perpendicular to the planar orientation of the wheel/hubcap. The longitudinal adapters also contain an opposing screwcap lid end 164 having threading 166 and a threaded screw portion 168 therebetween.

In the alternative embodiment of the system 100 shown in FIGS. 7-9 the two cylindrical tubes 114 are the same as described above, but herein have a screwcap lid engaging end 170 which has a terminal internal threading 170 (not shown), which is complementary in a male/female fashion to the threading 166 of the screwcap lid end 164. When assembled, the screw cap lid end 164 is screwed into the internal threading 170 of the screwcap lid engaging end 170. The two cylindrical tubes 114 also have a housing engaging end 172 and a circumference 118 as described herein which is substantially equivalent (i.e., about ±5%) to the circumference 174 of the screwcap lid end 164.

The alternative system 100 also contains a laser housing 120 as described herein which is situated on the housing engaging end 172 of one of the cylindrical tubes 114 and wherein the laser 122 (not shown) is oriented in a direction perpendicular to the longitudinal length 116 of the cylindrical tube 114. The cylinders 114 are attached in the fashion described herein to the laser housing 120 and the audible alarm housing 126 along the housing engaging end 172 as described herein.

The alternative system 100 also contains an audible alarm housing 126 containing an opening 128, a light detection device (not shown) in line with the opening 128, and an audible alarm 132 connected to the light detection device, wherein the audible alarm housing 126 is situated on the housing engaging end 172 of the other of the two cylindrical tubes 114, and wherein the opening 128 in the audible alarm housing 126 is oriented in a direction opposing the laser direction.

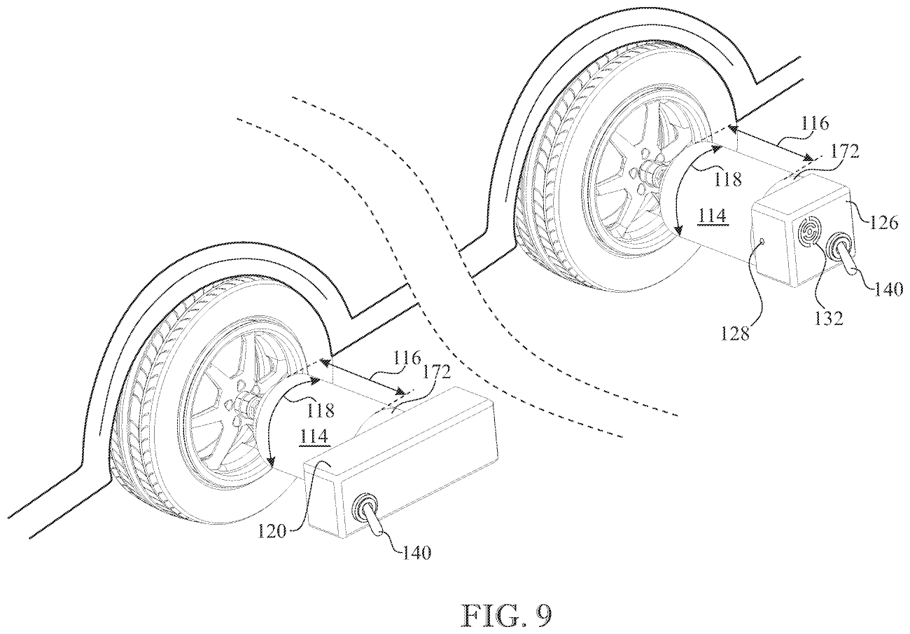

Preferably the two longitudinal adapters 160 are capable of being altered in longitudinal length 174 employing the threaded screw portion 168 and by turning an adjustment nut 176 located thereon. When the adjustment nut 176 is turned the longitudinal length 174 can be shortened to the extent that there is room in a channel (not shown) inside hubcap engaging end 162 which permits a segment of the threaded screw portion 168 to be enveloped into the hubcap engaging end 162, e.g., depending on the length of corresponding threading 169 which is present in such channel (not shown). The hubcap engaging end 162 contains a central cylinder 178 and an extending section 180 at an end thereof which is capable of engaging an internal portion of a center cap hole in a hubcap as is shown in FIG. 9. The central cylinder 178 further comprises external arced shims 182 therearound capable of adjusting a circumference of the hubcap engaging end 162 to different sized center cap holes. The shims 182 can be retained in place by a retainer 184, such as the nonlimiting example of an O-ring or any other elastic retaining element.

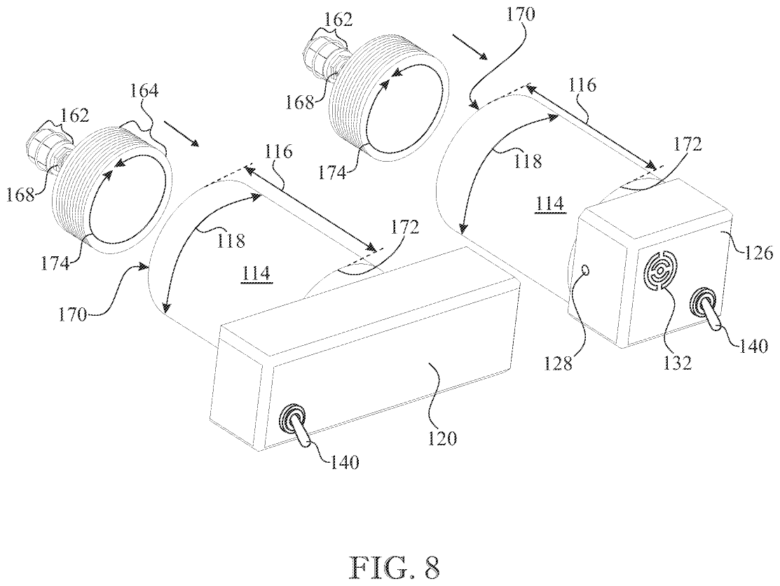

There is provided a method aligning tires of a vehicle comprising the vehicle tire alignment system 100 which contains the alternative longitudinal adapters 100 described herein. First the system 100 is provided (see FIG. 8) and then optionally, the vehicle can be jacked up equally on both sides of the vehicle or the vehicle can be placed on a lift. Although such a jacking or lifting of the car is not necessary, in that preferably the vehicle can be adjusted on the ground with the wheels as is, provided preferably, the wheels are properly and equally inflated and the front wheels are oriented in a straight forward direction. After this step, the center cap of the hubcaps on one side of the vehicle can be removed to expose a hubcap center hole in each wheel. Thereafter the system 100 can be used as described herein and a tie rod can be adjusted as necessary on the vehicle until the audible alarm sounds.

In an alternative embodiment, the system and/or method described herein can be in the absence of any one or more of a gyro sensor, a CPU, a controller, a monitor, computer software, a gyroscope, an inclinometer, and the like. In yet another alternative embodiment, the method described herein can be conducted without employing a full vehicle lift.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A vehicle tire alignment system comprising:
two circular disk-shaped adapters each having an adapter circumference, an inner solid circular center having a circular center circumference, which is less than, and is centered within, the adapter circumference, and wherein an area between the circular center circumference and the adapter circumference contains at least four arced stadium shaped apertures therethrough,
two cylindrical tubes each having a longitudinal length and a circumference substantially equivalent to the circular center circumference and wherein the longitudinal length of each cylindrical tube extends in a direction directly centered on and perpendicular from one of the inner solid circular centers;
a laser housing containing a laser therein, which laser housing is situated on an end of one of the cylindrical tubes which end opposes an end of the cylindrical tube which extends perpendicularly from inner solid circular center, and wherein the laser is oriented in a direction perpendicular to the longitudinal length of the cylindrical tube; and,
an audible alarm housing containing an opening, a light detection device in line with the opening, and an audible alarm connected to the light detection device, wherein the audible alarm housing is situated on an end of the other of the two cylindrical tubes, which end opposes an end of the cylindrical tube which extends perpendicularly from the inner solid circular center, and wherein the opening in the audible alarm housing is oriented in a direction opposing the laser direction.

2. The vehicle tire alignment system of claim 1, wherein the system is for a passenger vehicle.

3. The vehicle tire alignment system of claim 1, wherein the circular disk-shaped adapters have at least 5 apertures therethrough which are set at an arc of about 20° to about 50° and run along the inside of the circumference of the circular disk shaped adapter and outside the circumference of the inner solid circular center and are equally placed from each other.

4. The vehicle tire alignment system of claim 1, wherein the laser housing is rectangular, and the laser lies along the bottom of the longitudinal length of the rectangular housing and the housing has a level therein and an access window therein to observe the level therein to make sure the housing is level when the system is attached to a wheel.

5. A vehicle tire alignment system comprising:
two longitudinal adapters each having one hubcap engaging end capable of being attached into the center cap hole of a hubcap when the center cap of the hubcap is removed, an opposing screwcap lid end having threading, and a threaded screw portion therebetween;
two cylindrical tubes each having screwcap lid engaging end which has a terminal internal threading which is complementary to the threading of the screwcap lid end, an opposing housing engaging end, and a circumference substantially equivalent to the circumference of the screwcap lid end;
a laser housing containing a laser therein, which laser housing is situated on the housing engaging end of one of the cylindrical tubes, and wherein the laser is oriented in a direction perpendicular to the longitudinal length of the cylindrical tube; and,
an audible alarm housing containing an opening, a light detection device in line with the opening, and an audible alarm connected to the light detection device, wherein the audible alarm housing is situated on the housing engaging end of the other of the two cylindrical tubes, and wherein the opening in the audible alarm housing is oriented in a direction opposing the laser direction.

6. The vehicle tire alignment system of claim 5, wherein the system is for a passenger vehicle.

7. The vehicle tire alignment system of claim 5, wherein the two longitudinal adapters are capable of being altered in longitudinal length employing the threaded screw portion and by turning an adjustment nut located thereon.

8. The vehicle tire alignment system of claim 5, wherein the hubcap engaging end contains a central cylinder and an extending section at an end thereof which is capable of engaging an internal portion of a center cap hole in a hubcap.

9. The vehicle tire alignment system of claim 8, wherein the central cylinder further comprises external arced shims therearound capable of adjusting a circumference of the hubcap engaging end to different sized center cap holes.

10. The vehicle tire alignment system of claim 5, wherein the two cylindrical tubes each have a longitudinal length of from about 6 inches up to about 24 inches.

11. The vehicle tire alignment system of claim 5, wherein the laser housing is rectangular, and the laser lies along the bottom of the longitudinal length of the rectangular housing and the housing has a level therein and an access window therein to observe the level therein to make sure the housing is level when the system is attached to a wheel.

12. A method of aligning tires of a vehicle comprising:
providing a vehicle tire alignment system comprising:
two circular disk-shaped adapters each having an adapter circumference, an inner solid circular center having a circular center circumference, which is less than, and is centered within, the adapter circumference, and wherein an area between the circular center circumference and the adapter circumference contains at least four arced stadium shaped apertures therethrough;
two cylindrical tubes each having a longitudinal length and a circumference substantially equivalent to the circular center circumference and wherein the longitudinal length of each cylindrical tube extends in a direction directly centered on and perpendicular from one of the inner solid circular centers;
a laser housing containing a laser therein, which laser housing is situated on an end of one of the cylindrical tubes which end opposes an end of the cylindrical tube which extends perpendicularly from inner solid circular center, and wherein the laser is oriented in a direction perpendicular to the longitudinal length of the cylindrical tube; and,
an audible alarm housing containing an opening, a light detection device in line with the opening, and an audible alarm connected to the light detection device, wherein the audible alarm housing is situated on an end of the other of the two cylindrical tubes, which end opposes an end of the cylindrical tube which extends perpendicularly from the inner solid circular center, and wherein the opening in the audible alarm housing is oriented in a direction opposing the laser direction;
jacking up one side of a vehicle;
removing both tires from one side of the vehicle to expose both rotors and studs;
placing the portion of vehicle tire alignment system with laser housing over the studs and onto the rotor of one wheel by the circular disk-shaped adapter side;
placing the portion of the vehicle tire alignment system with the audible alarm housing over the studs and onto the rotor of the other wheel by the circular disk-shaped adapter side; and,
adjusting a tie rod on the vehicle until the audible alarm sounds.

13. The method of claim 12, wherein the step of jacking up one side of the vehicle is such that the side of the vehicle is raised to a level condition at which level condition the vehicle would operate at if it contained the vehicle tires thereon.

14. The method of claim 12, wherein the step of placing the portion of vehicle tire alignment system with laser housing over the studs and onto the rotor of one wheel by the circular disk-shaped adapter side further comprises:
sliding the system over the studs and
affixing the lug nuts of the tire onto the studs which emanate from the apertures in the adapter such that the adapter is flush with the rotor of the vehicle wheel; and,
conducting the same with the portion of the system comprising audible alarm housing to provide that the opening on the laser housing points towards the opening on the audible alarm housing.

15. The method of claim 12, wherein the alignment of the tires/wheels on one side of the housing comprises an alignment of any one or more of the toe, camber, caster and thrust.

16. The method of claim 12 wherein after the alignment step the system is removed from the wheels on the one side of the vehicle and then the method is repeated on the other side of the vehicle.

17. A method of aligning tires of a vehicle comprising:
providing a vehicle tire alignment system comprising:
two longitudinal adapters each having one hubcap engaging end capable of being attached into the center cap hole of a hubcap when the center cap of the hubcap is removed, an opposing screwcap lid end having threading, and a threaded screw portion therebetween;
two cylindrical tubes each having screwcap lid engaging end which has a terminal internal threading which is complementary to the threading of the screwcap lid end, an opposing housing engaging end, and a circumference substantially equivalent to the circumference of the screwcap lid end;
a laser housing containing a laser therein, which laser housing is situated on the housing engaging end of one of the cylindrical tubes, and wherein the laser is oriented in a direction perpendicular to the longitudinal length of the cylindrical tube; and,
an audible alarm housing containing an opening, a light detection device in line with the opening, and an audible alarm connected to the light detection device, wherein the audible alarm housing is situated on the housing engaging end of the other of the two cylindrical tubes, and wherein the opening in the audible alarm housing is oriented in a direction opposing the laser direction;
optionally, jacking up both sides of a vehicle or lifting the vehicle;
removing the center caps from each of two wheels on one side of the vehicle to expose a hubcap center hole in each wheel;
placing the hubcap engaging end of each longitudinal adapter into a separate hubcap center hole; and,
adjusting a tie rod on the vehicle until the audible alarm sounds.

18. The method of claim 17, wherein the step of jacking up comprising jacking up one side of the vehicle followed by jacking up the opposing side of the vehicle such that the vehicle is at a level condition.

19. The method of claim 18, wherein the alignment of the tires/wheels on one side of the housing comprises an alignment of any one or more of the toe, camber, caster and thrust.

20. The method of claim 18 wherein after the alignment step the system is removed from the wheels on the one side of the vehicle and then the method is repeated on the other side of the vehicle.
